(19) United States
(12) Patent Application Publication
(10) Pub. No.: US 2011/0278848 A1
(43) Pub. Date: Nov. 17, 2011

(54) Wave Energy Converting Assembly

(76) Inventor: Andreas Gimsa, Michendorf (DE)

(21) Appl. No.: 13/105,242

(22) Filed: May 11, 2011

(30) Foreign Application Priority Data
May 11, 2010 (DE) 10 2010 020 219.3
Nov. 4, 2010 (DE) 10 2010 050 188.3

(51) Int. Cl. F03B 13/18

(52) U.S. Cl. 290/53

(57) ABSTRACT

The invention describes a wave energy converting assembly which has a simple and rugged structure with high efficiency, which generates a high rotary speed of the generator and which moreover is suitable for a wide range of wavelengths and amplitudes. A further embodiment of the invention describes a wave energy converting assembly which can utilize the wave drift and has special flow floats.

The present invention relates to a wave energy converting assembly having a high generator speed.

The most varied arrangements of wave energy converting assemblies are known. There are systems having linear generators (Westwave), rocking arrangements (Kloss), piston systems (AW Energy Oy), gas pressure systems and many other systems.

These systems suffer from the following problems: They can admittedly convert wave energy into electrical energy, but have a low efficiency in this respect.

The low frequency and the changing amplitudes of the water waves represent a challenge which is difficult to master for linear generators. Their efficiencies are above all high at high frequencies. In addition, they have a complicated structure in comparison with commercial rotary generators. A beneficial optimization for a wide amplitude range of water waves is difficult due to different overlap regions of oscillator and stator.

Systems which first convert the high power density of the water wave into a gas pressure oscillation suffer from high conversion losses.

Most systems which have become known have a high price in addition to their low efficiency.

The present invention eliminates the described problems, i.e. it is the underlying object of the present invention to develop a wave energy converting assembly which avoids the named disadvantages and with which therefore a high efficiency is also achieved at low frequencies.

This object is achieved in accordance with the invention by a wave energy converting assembly having the features of the main claim.

Advantageous further developments are described in the subordinate claims.

The wave energy converting assembly includes a first main component and a second main component as well as a generator which serves the conversion of potential energy into electrical energy. The first main component is designed to lie below a water surface and to strive toward the water surface by buoyant forces. It can be fastened to the seabed to hold it at and in a defined position. The second main component is designed to float on the water surface and is connected to the first main component via a pulling cable which can be rolled up or via a linearly guided toothed rack, wherein the second main component is movable upwardly and downwardly in a vertical-linear manner with waves with respect to the first main component and with the main component and the second main component being guided mutually parallel to one another.

It is achieved by the parallel guidance of the two components that an amplitude of the waves is ideally utilized since no tilting of the two main components, and resulting from this, a reduced amplitude of the movement takes place. Potential energy of the second main component which can be converted into electrical energy by the connection between the two main components and the generator varies due to the movement on the water surface. Energy conversion can thus only take place by waves.

An embodiment can provide that the first main component includes at least one float which can preferably be guyed in a horizontal position to the seabed. The amplitude of the waves can be utilized particularly well by the horizontal position with respect to the seabed. Provision can further be made that the second main component includes a generator buoy which includes the components required for the energy conversion.

Provision can be made in a further embodiment that the first main component and the second main component are pivotally connected, with at least three limb pairs preferably being pivotally fastened to the first component and each including a joint between limbs of the limb pairs. A pivotal connection allows a mechanically stable connection, but nevertheless a connection simple to move along with the waves, for setting a vertical difference between the two components. Three limb pairs provide the advantage of a clear linear guidance.

A further embodiment provides that the first main component and the second main component are coupled to a first spring which can take up weight energy of the second main component, with the first main component and the second main component being in interaction with one another via the pulling cable or the linearly guided toothed rack. Provision can further be made that the second main component has the following major components in the direction of the force flow: the pulling cable which winds onto and off a spool body with the waves and whose lower end is fastened to the first main component; the spool body which takes up the pulling cable; a pendulum shaft which rotates to and fro with the pulling cable; a further spring whose one end is connected to the pendulum shaft and whose other end is connected to a frame construction of the second main component, with the further spring serving a pretensioning of the pulling cable and again pulling back the unwound pulling cable and thus driving a winding-up process; a freewheel which connects the pendulum shaft to a transmission and ensures that the driven wheels of the transmission always only rotate in one direction; the transmission which is disposed between the pendulum shaft and a generator shaft for increasing the rotational speed; the generator shaft with a flywheel as well as finally a generator. The second main component thus has the components which are required for energy conversion and which are better protected against spray water than in the first main component due to its positioning floating on the water surface. A simple conversion of the potential energy which is communicated via the pulling cable into electrical energy is possible by the components.

A further embodiment provides that the freewheel is arranged between the generator shaft and the transmission or within the transmission. This arrangement can be advantageous depending on the selected area of application.

Provision can be made in an embodiment that the pulling cable is guided centrally through a base of the second main component. The construction is hereby simplified and a symmetrical arrangement is made possible.

An embodiment provides that the first main component includes at least three floats which are fastened to at least one outlier of a mount and the second main component can be pressed off the mount by the waves, with the pulling cable being unwound to drive the generator. The floats can thus move with the low tide and high tide on a lack of fastening to the seabed or of a length-variable fastening.

Provision can further be made in an embodiment that the at least three floats are designed such that they have a small flow resistance. The energy of a wave is thus not already absorbed by the floats, but is rather available for energy conversion.

An embodiment can provide that regions of the at least three floats disposed lower below the water surface are weighted down with inner and/or outer weights to increase an inertia of a system including the mount, the outlier and the float. This system is thus less pronouncedly influenced by waves due to its inertia.

Provision can be made in an embodiment that the at least three floats are designed such that the waves are directed toward the second main component such that kinetic energy of a wave drift can be converted into potential energy of an increased wave amplitude. Provision can furthermore be made for this purpose that a conversion of the kinetic energy into the potential energy can be amplified by horizontal guide plates fastened to the mount and disposed below the water surface. The energy of the waves is thus utilized in a particularly efficient manner.

An embodiment provides that the first main component has a guying bar as well as a guying arrangement, preferably a guying cable, with the guying arrangement being fastened at one end to a lower end of the guying bar and at a further end to the seabed. The fastening to the seabed can furthermore be length variable to allow a fully tide-independent operation.

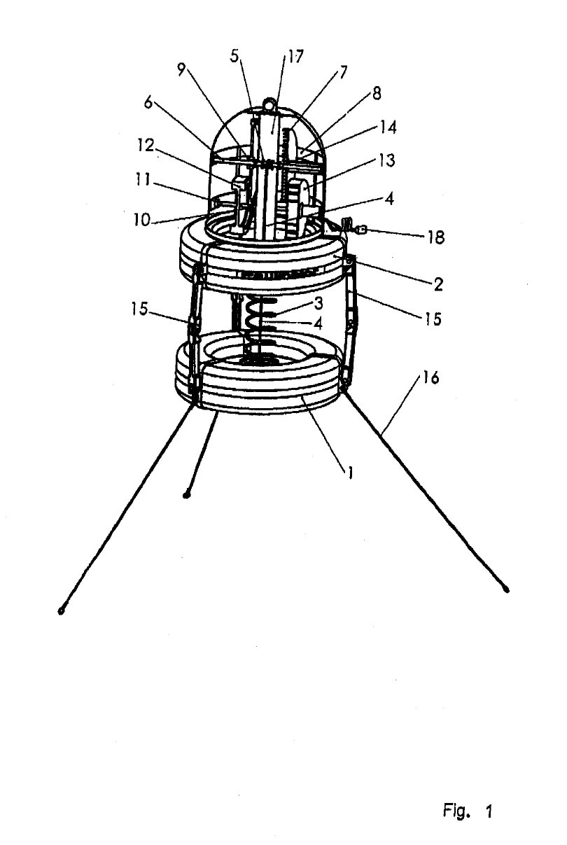

Embodiments of the invention are shown in the drawings and will be explained in the following with reference to FIGS. 1 to 9.

There are shown:

FIG. 1 a perspective view of a wave energy converting assembly with a sectional representation of the generator buoy;

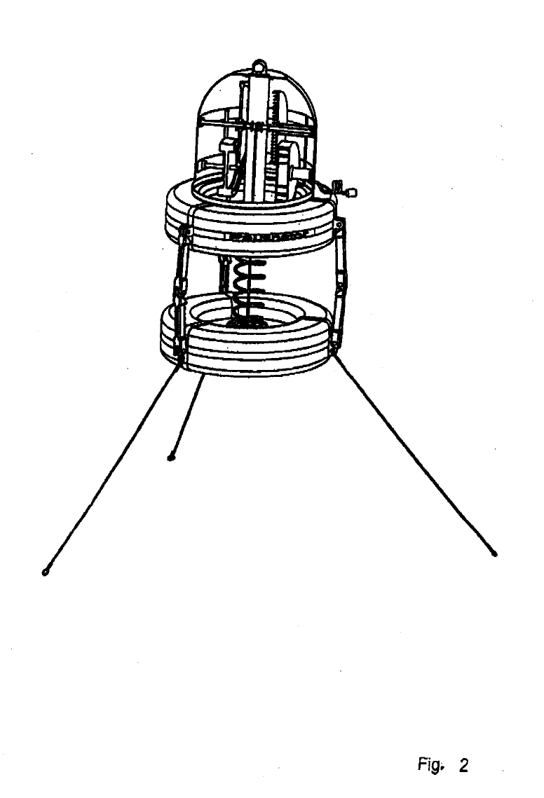

FIG. 2 a further perspective representation of a wave energy converting assembly corresponding to FIG. 1;

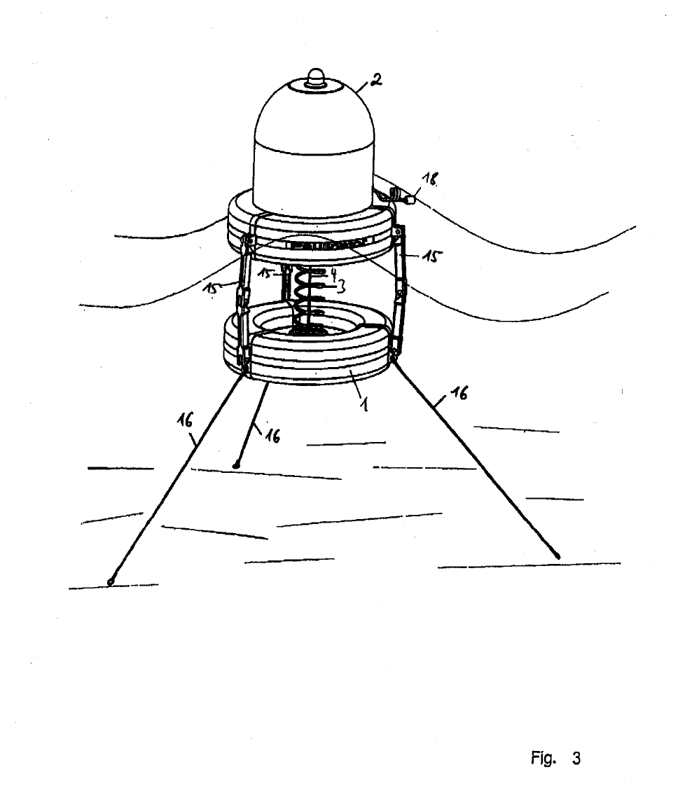

FIG. 3 a perspective view of a wave energy converting assembly floating on a wave with fastening to the seabed;

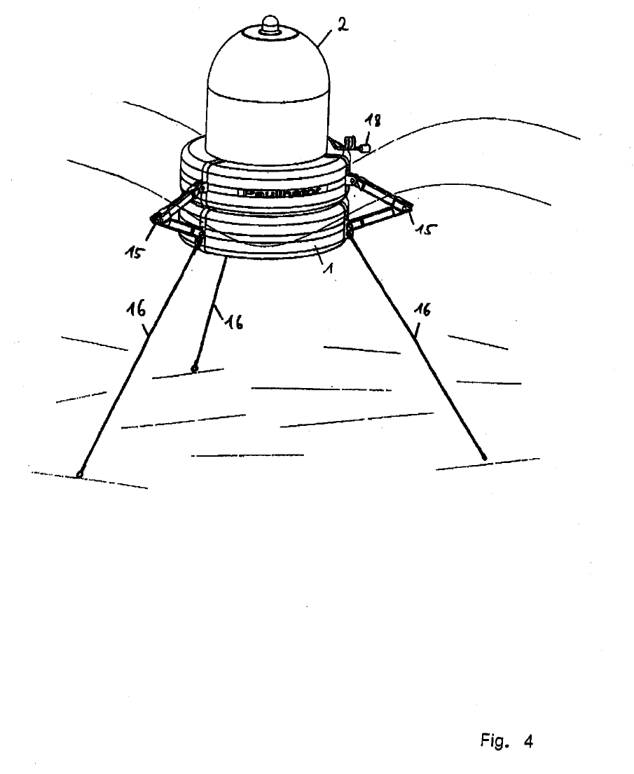

FIG. 4 a further perspective view corresponding to FIG. 3 of a wave energy converting assembly floating on a wave with fastening to the seabed with mutually guided first and second main components;

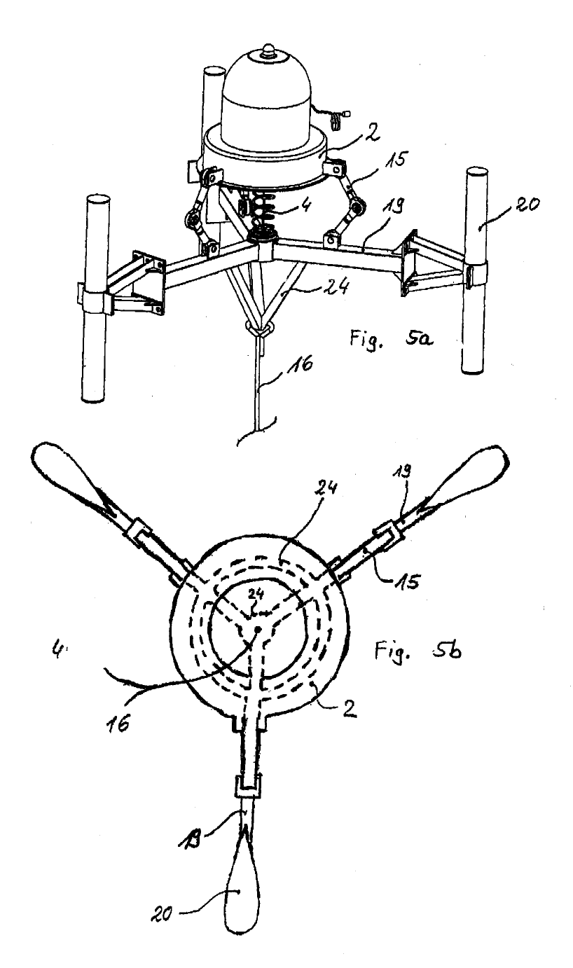

FIG. 5a a perspective view of an embodiment of a wave energy converting assembly with three floats;

FIG. 5b a plan view of the wave energy converting assembly shown in FIG. 5a;

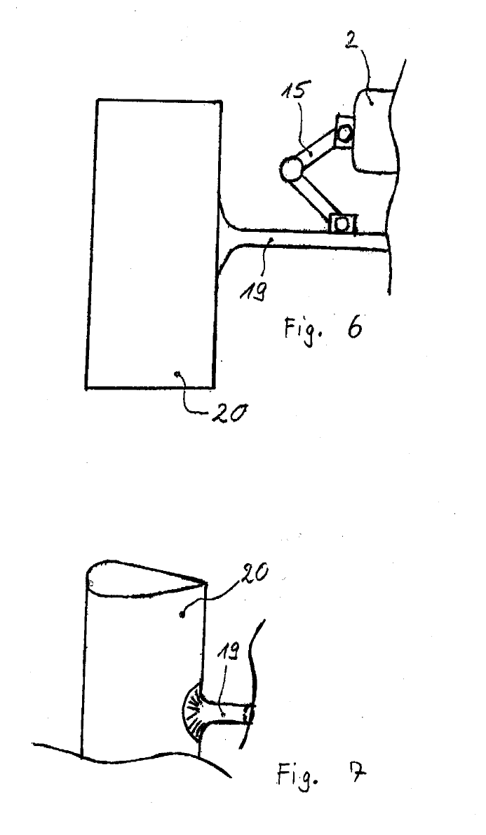

FIG. 6 a side view of a float with outlier of the wave energy converting assembly;

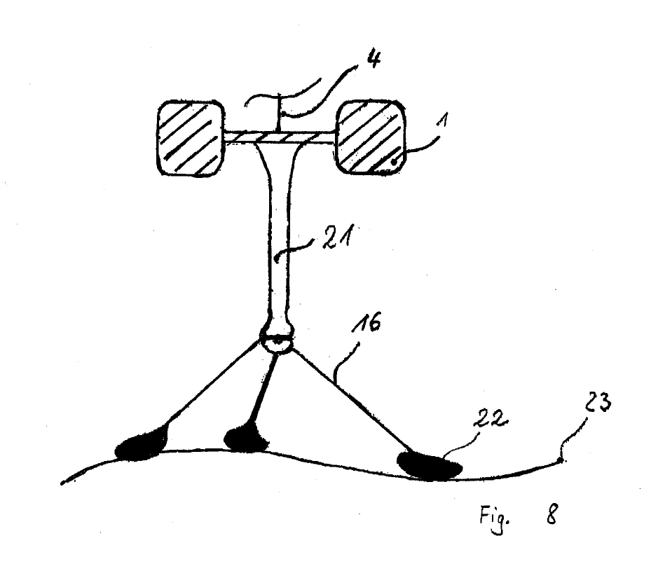

FIG. 7 a side view of a further embodiment of a float with outlier;

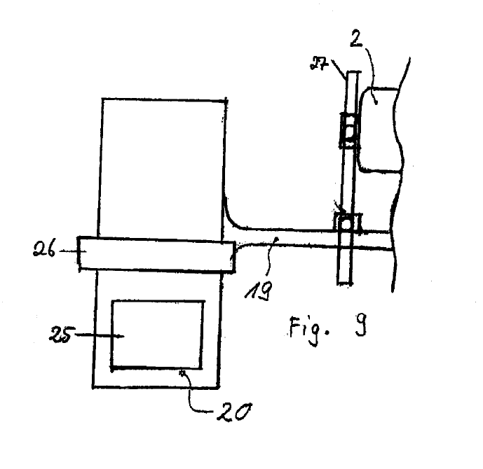

FIG. 8 a lateral view of a guying arrangement of a float toward the seabed; and

FIG. 9 a representation corresponding FIG. 6 with an alternative connection between a first main component and a second main component.

An embodiment of a wave energy converting assembly is shown in a perspective view in FIGS. 1 and 2. The wave energy converting assembly includes a first main component, in the embodiment shown a float 1, and a second main component, in the embodiment shown a generator buoy 2. The generator buoy 2 is shown in a sectional representation to show the components disposed in a dome of the generator buoy. The float 1 and the generator buoy 2 are guided parallel to one another, i.e. a lower side of the generator buoy 2 always extends parallel to an upper side of the float 1. Components which are the same are provided with the same respective reference numerals in the drawings.

The structure of the wave energy converting assembly in accordance with the invention (FIG. 1 and FIG. 2) is characterized in that a wave energy converting assembly comprises two main components: a float 1 which is disposed under water, strives toward the surface of the sea due to its buoyancy and is guyed in a horizontal position to the seabed and a generator buoy 2 which floats on the water, is connected pivotally and via a pulling cable 4, which can be wound up, to the float 1 and moves upwardly and downwardly in a vertical-linear manner with the waves with respect thereto. The pulling cable 4 is in this respect guided centrally through a base of the second main component and can include a steel cable.

The float 1 and the generator buoy 2 are coupled to a compression spring 3 which can take up the weight energy of the generator buoy 2, and both main components are in interaction with one another via the pulling cable 4.

The design of the compression spring 3 with respect to its spring constant and of the float 1 with respect to its buoyancy are such in the embodiment shown that the generator buoy 2 cannot pressure the float 1 into a deeper position under water via the compression spring 3 on the downward movement, but rather only tensions the compression spring 3.

The generator buoy 2 includes the following major components in the direction of the force flow:
a pulling cable 4 which winds onto and off a spool body 5 with the waves and whose lower end is fastened to the float 1;
a spool body 5 which takes up the pulling cable 4;
a pendulum shaft 6 which rotates to and fro with the pulling cable;
a spring 7 whose one end is connected to the pendulum shaft 6 and whose other end is fixedly connected to a frame construction 8 of the generator buoy 2, said spring serving a pretensioning of the pulling cable 4 and pulling back the unwound pulling cable 4 and thus driving a winding-up process;
a freewheel 9 which connects the pendulum shaft 6 to a transmission 10 and ensures that the driven wheels of the transmission 10 always only rotate in one direction;
a transmission 10 between the pendulum shaft and generator shaft 11 for increasing the rotational speed;
a generator shaft 11 with a flywheel 12; and
a generator 13.

The arrangement of the freewheel 9 can take place between the pendulum shaft 6 and the transmission 10, but can also take place, in an alternative embodiment, between the generator shaft 11 and the transmission 10 or within the transmission 10.

The outer rings of the ball bearings of both shafts 6 and 11, the spring housing and the generator housing are fixedly connected to the frame construction 8 which is located on the inner side of the dome of the generator buoy 2.

Shaft seals 14 seal the pendulum shaft 6 in a watertight manner with respect to the spray water in the region of the inner pipe 17.

Instead of the pulling cable 4, a linearly guided toothed rack can also be used. The spool body 5 is then designed as a toothed wheel in this variant which drives the pendulum shaft 6. In this respect, the larger construction height of the correspondingly modified generator buoy 2, the friction of the toothed rack against the toothed wheel and the required linear guidance of the toothed rack are disadvantageous. However, the function of the compression spring 3, which otherwise takes up the weight energy of the generator buoy 2, can be taken over by the spring 7 since a pulling cable 4 is no longer present which needs to be retracted.

A linear guidance which in the present embodiment includes three limb pairs 15 which each have a joint between limbs of the limb pairs 15 allows a guided variation of a spacing of the generator buoy 2 and the float 1. The limb pairs 15 are for this purpose fastened at one end to the float 1 and at another end to the generator buoy 2. The spacing between the float 1 and the generator buoy 2 can be varied by the joint between the two ends. A guying arrangement 16, three guying cables in the embodiment shown in FIGS. 1 and 2, allows a fastening of the wave energy converting assembly to the seabed or to another liquid-covered base. The electrical energy generated can be led off via an electric connection 18; alternatively, the energy can be used to operate electric consumers of the generator buoy such as lamps, LEDS or sensors. The electric connection 18 is attached to the generator buoy 2 in the embodiment shown and is located above the water surface; however, it can also be arranged below the water surface.

The generator 13 can also be located in the first main component, that is, below the water surface, in an embodiment which is not shown. In this case, the electric connection 18 is also attached to the first main component.

FIGS. 3 and 4 illustrate the manner of operation of the wave energy converting assembly. The wave energy converting assembly has to be designed in accordance with the typical wave amplitudes. In calm seas, the generator buoy 2 floats on the sea surface and the float 1 is located so far under water that in each case two limbs of the three limb pairs have the same mean angle to one another (between that of FIG. 3 and FIG. 4).

The generator buoy 2 moves with the incoming wave toward the wave crest due to the buoyancy of the float ring fastened at the bottom (FIG. 3). The pulling cable 4 pulls tangentially at the spool body 5 and unwinds while the spool body 5 starts to rotate.

The transmission 10, the generator shaft 11, the flywheel 12 and the generator 13 are driven by the movement of the spool body 5 which is fixedly connected to the pendulum shaft 6. A power flow is generated in the generator. On this upward movement of the generator buoy 2, the spring 7, which already had a bias before the upward movement of the generator buoy 2, is further tensioned.

At the same time, the compression spring 3 is relaxed by the upward movement of the generator buoy 2 and the energy stored in it is likewise transmitted via the pulling cable 4 to the generator 13.

After the wave crest has passed the generator buoy 2, it moves perpendicularly down into the wave trough (FIG. 4). On the now opposite direction of rotation of the pendulum shaft 9, the freewheel 9 decouples it from the further continuing movement of the transmission 10, of the generator shaft 11, of the flywheel 12 and of the generator rotor 13. The spring 7 winds the pulling cable 4 onto the spool body 5. The compression spring 43 is tensioned by the inherent weight of the generator buoy 2 during its downward movement into the wave trough. This wave energy converting assembly thus works with a dual effect. It converts the energy of the sea into electrical energy both on its upward movement and on its downward movement.

The flywheel 12, together with the other rotating inert masses, provides a uniformly high rotary speed of the generator shaft 11.

To cushion a possible collision of the float 1 and the generator buoy 2, elastic buffer elements can be used between the two components. The buffer effect, however, also occurs by a briefly deeper immersion of the float 1 as a consequence of the collision.

To avoid a possible overstretching of the three joints of the linear guide 15, abutments can be arranged in them. Alternatively to this, the bounding of the upward movement of the generator buoy 2 can take place via the unwound pulling cable 4.

The embodiment shown in FIGS. 1 to 4 can, however, not utilize the wave drift. To ensure the proper generator function also at low tide and at high tide, its linear guide would have to have a very large dimension or a complex adjustment mechanism would have to be installed for the height level of the float lying under the water.

FIGS. 5 to 8 illustrate a further embodiment of a wave energy converting assembly in accordance with the invention by which a wave drift can also be utilized. A wave energy converting assembly whose basic structure corresponds to the embodiment shown in FIGS. 1 to 4 is characterized in that, instead of one float 1, at least three floats 20 are fastened to the outliers 19 of a mount 24 and the generator buoy 2 can then be pressed off this mount with the wave movement and in so doing the pulling cable 4 is unwound to drive the generator.

The floats 20 can move toward the bottom of the sea at low tide and at high tide when, in accordance with the invention, the guying arrangement 16 is lacking or is length variable. In this respect, the floats 20 can be designed so that they have a small flow resistance in order not to absorb the wave energy for the generator buoy 2.

To lower the wave sensitivity in a comparable manner to a large ship and to form a fixed floating point with respect to the generator buoy 2, the floats 20 can be designed so that their regions lying deeper in the water are weighed down by inner or outer weights. The inertia of the system: mount 24, outliers 19 and floats 20 is thus increased.

An increase in the utilization of the wave energy is obtained in that the floats 20 are designed so that they direct the waves to the generator buoy 2 such that the kinetic energy of the wave drift is not converted into potential energy of an increased wave amplitude. This effect can be amplified with horizontal guide plates fastened to the mount 24 and disposed under water.

The wave energy converting assembly has a further design in accordance with the invention (FIG. 8) when its guying cables 16 of the float 1 are not fastened directly thereto, but at the lower end of a guying bar 21 fastened to the float 1. Alternatively, only one cable 16 can be guyed from there to the bottom of the sea. This cable van be length variable at one end.

A further embodiment is illustrated in FIG. 9. The linear guide now includes one toothed rack 27 instead of the three limb pairs 15, said toothed rack being fixedly connected to one of the main components at one end and to a toothed wheel at the other end and being able to be moved via it. In addition, a weight 25 to increase the inertia is attached to the lower region of the float which is remote from the generator buoy 2. A guide plate 26 is furthermore centrally fastened to the float.

Further aspects which are covered by the invention are named in the following. An aspect of the invention includes a wave energy converter characterized in that it comprises two main components: a float 1 which is disposed under water, strives toward the surface of the sea due to its buoyancy and is guyed in a horizontal position to the seabed and a generator buoy 2 which floats on the water, is connected pivotally and via a pulling cable 4, which can be wound up, to the float and moves upwardly and downwardly in a vertical-linear manner with the waves with respect thereto.

A further aspect of the invention includes a wave energy converter in accordance with the first aspect, characterized in that the float 1 and the generator buoy 2 are coupled to a spring 3 which can take up the weight energy of the generator buoy 2 and both main components are in interaction with one another via the pulling cable 4.

A further aspect of the invention includes a wave energy converter in accordance with one of the preceding aspects, characterized in that the generator buoy includes the following major components in the direction of the force flow:
a pulling cable 4 which winds onto and off a spool body 5 with the waves and whose lower end is fastened to the float 1;
a spool body 5 which takes up the pulling cable 4;
a pendulum shaft 6 which rotates to and fro with the pulling cable;
a spring 7 whose one end is fixedly connected to the pendulum shaft 6 and whose other end is fixedly connected to a frame construction 8 of the generator buoy 2, said spring serving a pretensioning of the pulling cable 4 and again pulling back the unwound pulling cable 4 and thus driving a winding-up process;
a freewheel 9 which connects the pendulum shaft 6 to a transmission and ensures that the driven wheels of the transmission 10 always only rotate in one direction;
a transmission 10 between the pendulum shaft and generator shaft for increasing the rotary speed;
a generator shaft 11 with flywheel 12; and
a generator 13.

A further aspect of the invention includes a wave energy converter in accordance with one of the preceding aspects, characterized in that the arrangement of the freewheel 9 does not take place between the pendulum shaft 6 and the transmission, but rather between the generator shaft 11 and the transmission 10 or within the transmission.

A further aspect of the invention includes a wave energy converter in accordance with one of the preceding aspects, characterized in that, instead of one float 1, at least three floats 20 are fastened to the outliers 19 of a mount 24 and the generator buoy 2 can then be pressed off this mount with the waves and in so doing the pulling cable 4 is unwound to drive the generator.

A further aspect of the invention includes a wave energy converter in accordance with one of the preceding aspects, characterized in that the floats 20 are designed so that they have a small flow resistance.

A further aspect of the invention includes a wave energy converter in accordance with one of the preceding aspects, characterized in that the floats 20 are designed so that their regions lying deeper in the water are weighed down by inner or outer weights to increase the inertia of the system: mount 24, outliers 19 and floats 20.

A further aspect of the invention includes a wave energy converter in accordance with one of the preceding aspects, characterized in that the floats 20 are designed so that they direct the waves to the generator buoy 2 such that the kinetic energy of the wave drift is converted into potential energy of an increased wave amplitude.

A further aspect of the invention includes a wave energy converter in accordance with the preceding aspect, characterized in that this effect is amplified by horizontal guide plates fastened to the mount 24 and lying under water.

A further aspect of the invention includes a wave energy converter in accordance with one of the preceding aspects, characterized in that the guying cables 16 of the float 1 are not directly fastened thereto, but are guyed to the lower end of a guying bar 21; or in that, alternatively, only one cable 16 is guyed from there to the bottom of the sea.

### REFERENCE NUMERAL LIST

1. float which is guyed toward the seabed
2. generator buoy which moves up and down with the wave
3. compression spring which takes up the weight energy
4. pulling cable which winds up and unwinds with the wave movement
5. spool body which takes up the pulling cable 4
6. pendulum shaft which rotates to and fro with the pulling cable movement
7. spring which holds the puling cable 4 taut
8. frame construction of the generator buoy
9. freewheel
10. transmission
11. generator shaft
12. flywheel
13. generator
14. seals of the pendulum shaft 6
15. linear guide of the generator buoy 2
16. guying arrangement of the float 1 to the bottom of the sea
17. inner tube for the watertight bounding of the pulling cable 4 and the spool body 5 from the inner space of the generator buoy 2
18. electric connection
19. outliers for fastening the floats 20
20. floats with flow section
21. guying bar of the float 1
22. weight
23. bottom of the sea
24. mount for outliers 19 and floats 20
25. weight
26. guide plate
27. toothed rack

1. A wave energy converting assembly comprising a first main component and a second main component as well as a generator (13) for converting potential energy into electrical energy, wherein the first main component is designed to lie below a water surface and to strive toward the water surface by buoyance, and can be fastened to a seabed (23), and the second main component is designed to float on the water surface and is connected to the first main component via a pulling cable (4) which can be rolled up or via a linearly guided toothed rack, wherein the second main component is movable upwardly and downwardly in a vertical-linear manner with waves with respect to the first main component, characterized in that the main component and the second main component are guided parallel to one another.

2. A wave energy converting assembly in accordance with claim 1, characterized in that the first main component includes at least one float (1) which can preferably be guyed in a horizontal position to the seabed (23).

3. A wave energy converting assembly in accordance with either of claim 1 or 2, characterized in that the second main component includes a generator buoy (2).

4. A wave energy converting assembly in accordance with claim 1, characterized in that the first main component and the second main component are pivotally connected, with at least three limb pairs (15) preferably being pivotally fastened to the first main component and to the second main component and including a respective joint between limbs of the limb pairs (15).

5. A wave energy converting assembly in accordance with claim 1, characterized in that the first main component and the second main component are coupled to a first spring (3) which can take up weight energy of the second main component, with the first main component and the second main component being in interaction with one another via the pulling cable (4) or the linearly guided toothed rack.

6. A wave energy converting assembly in accordance with claim 1, characterized in that the second main component has the following major components in the direction of force flow:
the pulling cable (4) which winds onto and off a spool body (5) with the waves and whose lower end is fastened to the first main component;
the spool body (5) which takes up the pulling cable (4);
a pendulum shaft (6) which rotates to and fro with the pulling cable (4);
a further spring (7) whose one end is connected to the pendulum shaft (6) and whose other end is connected to a frame construction (8) of the second main component, with the further spring (7) serving a pretensioning of the pulling cable (4) and again pulling back the unwound pulling cable (4) and thus driving a winding-up process;
a freewheel (9) which connects the pendulum shaft (6) to a transmission (10) and ensures that the driven wheels of the transmission (10) always only rotate in one direction;
the transmission (10) which is disposed between the pendulum shaft (6) and a generator shaft (11) for increasing the rotary speed;
the generator shaft (11) with a flywheel (12)
a generator (13).

7. A wave energy converting assembly in accordance with claim 6, characterized in that the free wheel (9) is arranged between the generator shaft (11) and the transmission (10) or within the transmission (10).

8. A wave energy converting assembly in accordance with claim 1, characterized in that the pulling cable (4) is guided centrally through a base of the second main component.

9. A wave energy converting assembly in accordance with claim 1, characterized in that the first main component includes at least three floats (20) which are fastened to at least one outlier (19) of a mount (24) and the second component can be pressed off the mount (24) by the waves, with the pulling cable (4) being unwound to drive the generator (13).

10. A wave energy converting assembly in accordance with claim 1, characterized in that the at least three floats (20) are designed such that they have a small flow resistance.

11. A wave energy converting assembly in accordance with claim 9, characterized in that regions of the at least three floats (20) disposed lower below the water surface are weighted down with inner and/or outer weights to increase an inertia of a system including the mount (24), the outlier (19) and the float (20).

12. A wave energy converting assembly in accordance with claim 9, characterized in that the at least three floats (20) are designed such that the waves are directed toward the second main component such that kinetic energy of a wave drift can be converted into potential energy of an increased wave amplitude.

13. A wave energy converting assembly in accordance with claim 12, characterized in that a conversion of the kinetic energy into the potential energy can be amplified by horizontal guide plates fastened to the mount (24) and disposed below the water surface.

14. A wave energy converting assembly in accordance with claim 1, characterized in that the first main component has a guying bar (21) as well as at least one guying arrangement (16), preferably a guying cable, with the guying arrangement (16) being fastened at one end to a lower end of the guying bar (21) and at a further end to the seabed (23).

15. A wave energy converting assembly in accordance with claim 1, characterized in that a fastening of the wave energy converting assembly to the seabed (23) is length variable to allow a tide-independent operation.
